(19) United States
(12) Patent Application Publication
(10) Pub. No.: US 2004/0166854 A1
(43) Pub. Date: Aug. 26, 2004

(54) Method and apparatus for notifying an end user of a request for communication

(76) Inventor: Mark B. Longacre, Denver, CO (US)

Correspondence Address: Judson Cary, 107 W 4th Ave, Denver, CO, 80223, US

(21) Appl. No.: 10/370,929

(22) Filed: Feb. 20, 2003

(51) Int. Cl. H04Q 7/20

(52) U.S. Cl. 455/435.1; 455/422.1

(57) ABSTRACT

The invention is drawn to a method and apparatus for notifying an end user of a wireless terminal (e.g., a cell phone) of a request for communication. When an incoming request for communication is received by the wireless terminal, the wireless terminal generates an acknowledgement return signal. The return signal comprises a unique wireless terminal identification associated with the wireless terminal. The return signal is received by a notifier device worn on or close to the end user. The notifier decodes the return signal to obtain the unique terminal identification. A notification signal is generated in response to obtaining the unique terminal identification. Such notification signal may be, for example, a tactile, light, or sound indicator, or combinations thereof. As the primary function of the notifier device is simply to monitor for the return signal and produce a notification, the complexity and size of the notifier device is relatively smaller than a fully functional wireless terminal.

### FIELD OF THE INVENTION

The present invention relates generally to wireless communications services, and more specifically to remotely notifying an end user of a request for communication.

### BACKGROUND OF THE INVENTION

There are three typical methods of notifying end users of a wireless terminal (e.g., a cell phone or pager) that a request for communication has been sent. The first and most common is an audible tone or tones that are the functional equivalent of traditional “ringing” of a telephone. The second method is an inaudible transducer that produces a vibration (so-called “silent” mode) in the wireless terminal that can be felt by the end user when the wireless terminal is in direct contact, or very close to, the end user. The third is some form of visual indication, usually an alpha-numeric display of caller-ID, possibly accompanied by a light or flashing light, that appears in the screen of the wireless terminal. This third form is often provided in combination with either of the first two notification methods.

While all three typical wireless terminal notification methods are well understood by end users, there are many instances where the end user is simply unaware of the request for communication. As a result, the communication request goes unanswered. The reasons for the unanswered communication requests are several. The wireless terminal may be set to produce audible tones, but the tones are effectively made inaudible by the cover of a briefcase, handbag, or purse. The audible tones may also be too distant to hear, or difficult to hear due to surrounding environmental noise; for example, in a noisy bar. Likewise, the “silent” mode is ineffective if the terminal is not in direct physical contact with the body of the end user, or very close to the end user (e.g., on the table in front of the end user). And, the visual notification is not perceptible unless the face of the wireless terminal is in direct sight of the end user, and the end user is actually looking at the wireless terminal. The visual notification is ineffective if the wireless terminal is turned over face down, or is in a jacket, briefcase, purse, etc.

As such, a need exists for an apparatus and method to more reliably notify the end user of a wireless terminal of a request for communication.

Typical paging systems can notify users of a call or provide other textual information. However, such systems receive signals from a broadcast signal. As such, receivers in paging devices must be relatively high powered and technologically sophisticated in order receive signals from a great distance and discriminate unique signals in the broadcast. Power and interference often create technical challenges in such systems.

Although wireless terminals are convenient, and increasingly made to a smaller scale, for various reasons many end users simply do not carry wireless terminal on, or close to, their person. A complete wireless terminal is necessarily bulky because of the technology required to make them fully functional—e.g., audio out, audio in, keypad, display, radio frequency two-way wireless communication capabilities, ergonomic handset, etc. As such, many end users do not carry the wireless terminal on, or in, their clothing, or otherwise directly on themselves. This is often for the practical reasons of bulk, and also for fashion reasons (e.g., a clip-on cell phone on a formal ball gown does not fit well, or look fashionable).

As such, a need exists for an apparatus and method to notify the end user of a wireless terminal of a request for communication via a convenient and relatively small device.

### BRIEF SUMMARY OF THE INVENTION

It is an object of the present invention to reliably notify end users of wireless terminals of an incoming request for a communication, overcoming the known limitations of present wireless terminal notification, some of which are noted above.

It is another object of the present invention to notify an end user of an incoming request for communication in an unobtrusive and convenient manner via a device that is distinct from the wireless terminal and is relatively smaller than a typical wireless terminal.

A small notifier device, for example packaged as a slender patch much like a Band-Aid® or other slender device, is associated with an end user wireless terminal by short-range radio frequency (RF) link or other similar wireless means. The notifier device is worn on, or is placed near, the end user. A request signal for wireless communication is sent from a base station to the end user wireless terminal, typically via RF broadcast. The requested end user wireless terminal receives the request signal, and sends a return signal back to the base station indicating that the end user wireless terminal received the request signal. When the return signal is sent to the base station by the end user wireless terminal, the nearby notifier device also receives the acknowledgement via the same return signal RF link. In response to the return signal, the notifier device produces an end user notification signal. The notification signal may be a tactile notification, or some other method of notifying the end user of the incoming request for communication, e.g., light, sound, electrical pulse, etc. Upon user awareness of notification, the nearby wireless terminal can be removed from briefcase, pocket, or purse, and answered in a timely fashion. As the primary function of the notifier device is simply to monitor for the return signal and produce a notification, the complexity and size of the notifier device is relatively smaller than a fully functional wireless terminal.

### BRIEF DESCRIPTION OF THE SEVERAL VIEWS OF THE DRAWING

FIG. 1 illustrates a block and flow diagram of a wireless communication network that employs the present invention.

FIG. 2 illustrates one embodiment of a method for practicing the present invention.

FIG. 3 illustrates a block diagram of a notifier device that employs the present invention.

### DETAILED DESCRIPTION OF THE INVENTION

The present invention summarized above and defined by the enumerated claims below may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

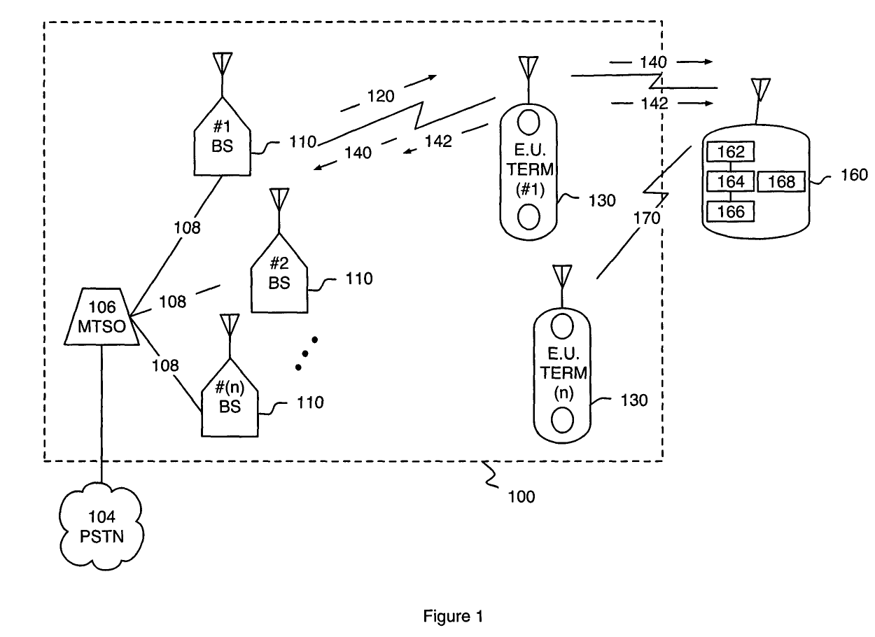

Referring now to FIG. 1, cellular telephone system 100 is shown. Base station 110 transmits communication request signal 120 to wireless terminal 130. Base station 110 is typically a cellular or other similar wireless radio frequency (RF) transceiver base station known by those skilled in the art. Base station 110 is also typically in communication, via a wireless or wired coupling, through none, one, or more base stations, cells, or other devices 108, to a switching station or central office 106, and, in turn, to the public switch telephone network 104.

Base station 110 typically uses an RF overhead signaling channel to set up, supervise, and terminate voice or data communication sessions with wireless terminals 130, 132-134 in the system 100. Using the overhead RF channel, base station 110 is in two-way contact with each wireless terminal 130, 132-134 within the serving area of system 100, performing a variety of administrative functions in the overhead RF spectrum, such as authentication, verification, detection of illegal “cloned” cell phones, identification of “roaming” users, and assessing the point at which a given active communication session needs to be handed off to the next cell in the system 100.

Request signal 120 is transmitted in the overhead RF channel. Request signal 120 modulates the RF link by using various techniques, including, for example, Time Division Multiple Access (TDMA), Code Division Multiple Access (CDMA), Coded Orthogonal Frequency Division Multiplexing (COFDM), GSM, G3, and other similar modulation techniques well known to those skilled in the art. Request signal 120 includes an identifier, flag, or other information 122 that is unique to a particular end user wireless terminal 130. As such, end user wireless terminal 130 can discern that the request signal 120 is for that particular end user wireless terminal 130, as opposed to other wireless terminals 132-134 on the system 100.

End user wireless terminal 130 may be, for example, a cellular telephone, pager, PDA, BlackBerry, or other similar wireless voice or data communication device. In the event that wireless terminal 130 is on and operational, upon receipt of request signal 120, wireless terminal 130 transmits an automatic return signal 140 back to base station 110. Return signal 140 is generally transmitted in the administrative overhead RF channel, and is typically transmitted before any notification to the end user (e.g., before the wireless terminal rings or vibrates, etc., and before the request for communication is “answered” by the end user).

Return signal 140 contains a unique terminal identification 142 of the wireless terminal 130 that received request signal 120. Terminal identification 142 is used by Mobile Telephone Switching Office (MTSO) 175 to process the communication request. If there is no return signal 140 (and 142) forthcoming from wireless terminal 130, MTSO 175 assumes that wireless terminal 130 is either switched off, not operational, and/or out of RF range of system 100. In such case, the calling party may be routed to voice mail, or to a standard network recording, depending on service option selected by the end user.

Although the return signal 140 and the terminal identification 142 is intended for receipt by MTSO 175 or other devices in system 100, it is also possible for other devices near the wireless terminal 130 to receive return signal 140, typically in the RF spectrum. Thus, in accordance with the present invention, notifier 160 comprises receiver 162 for receiving return signal 140, a decoder or processor 164 for obtaining or recovering terminal identification 142 from return signal 140, transducer 166 or some other mechanism to create end user notification signal 170, and a power source 168.

Notifier 160 is programmed or otherwise associated with a wireless terminal 130 to recognize terminal-specific identification 142 transmitted from the associated wireless terminal 130. In an optional embodiment of the invention, notifier 160 can be associated with multiple wireless terminals 130/terminal identifiers 142. In another embodiment a different notification signal 170 (e.g., one beep, two beeps, etc.) are associated with each wireless terminal 130 known by notifier 160 so that the end user may discern which wireless terminal 130 is receiving a request for communication. For example, one tactile indication of notification signal 170 may indicate a first wireless terminal 130, and a second tactile indication of notification signal 170 may indicate a second wireless terminal 130.

In one embodiment notification signal 170 is a tactile indicator such as a small vibrating sensation or a low voltage electrical stimulation. Such a tactile notifier 160 could be worn close to the body of the end user, or even on the skin in the form of an adhesive patch similar to a Band Aid®. Alternatively, notifier 160 could produce a light or sound notification signal 170. Such a notifier 160 may take the form of a ring, necklace, earrings, lapel pin, or other object on or near the end user (e.g., a so-called “mood” ring worn by the end user could produce both sound and light).

Typically notifier 160, and its components, would require only a few milliwatts of power. Notifier 160 can be powered by a small battery 168, similar to those used in hearing aids or watches. Alternatively, notifier 160 could be powered by solar power from natural lighting or room lighting, or ergonomic movement (similar to the technology used in Rolex® watches). Thin flexible solar powered strips are known in the art and are commercially available.

Association or programming of notifier 160 with wireless terminal 130 and, in particular with terminal identification 142, may be accomplished by the service provider at the point of sale, by a third party, or directly by an end user. “Manual” methods of programming notifier 160 may be used. For example, the user could enter the serial number or ESN number imprinted on each wireless terminal 130, for example using a computer or other input device. Such numbers are unique and typically included in the return signal 140 as the terminal identification 142. After entering such numbers, a device can be used to program one or more notifiers to discriminate to such terminal identification (or multiple terminal identification numbers if desired). Although end users typically perform complex steps to customize, establish, or select various service features on their wireless terminals 130, the present invention does not require any programming of the wireless terminal 130 itself.

Although many other methods of programming notifier 160 to be associated with wireless terminal 130 (and 142) are well known to those skilled in the art, one method of associating notifier 160 with one or more wireless terminals 130, 142 is a “self-learning” process similar to a technique well known in programmable “generic” hand-held remote-control units designed for control of individual or multiple consumer electronics devices such as television sets, VCRs and DVD players. These programmable remote control devices can be set up to understand and control the particular device(s) by exercising a few user-friendly steps in front of the device(s) to be controlled. Communication in the consumer electronics example is via infrared light modulated by digital information. In the case of the present invention, one method of programming notifier 160 may be accomplished placing one or more “blank” notifiers 160 in a programming station, then making a call to the desired wireless terminal 130 from another telephone device. The outgoing return signal 140 and terminal identification 142 is then output by wireless terminal 130 and “burned” into the notifier or notifiers 160. The process is repeated if the notifier 160 is to be programmed for multiple wireless terminals 130, or multiple notifier devices are programmed for one or more of the same wireless terminals 130. Once all wireless terminals 130 are “input” into the notifier 160, a function to complete or “lock” the notifiers 160 is performed.

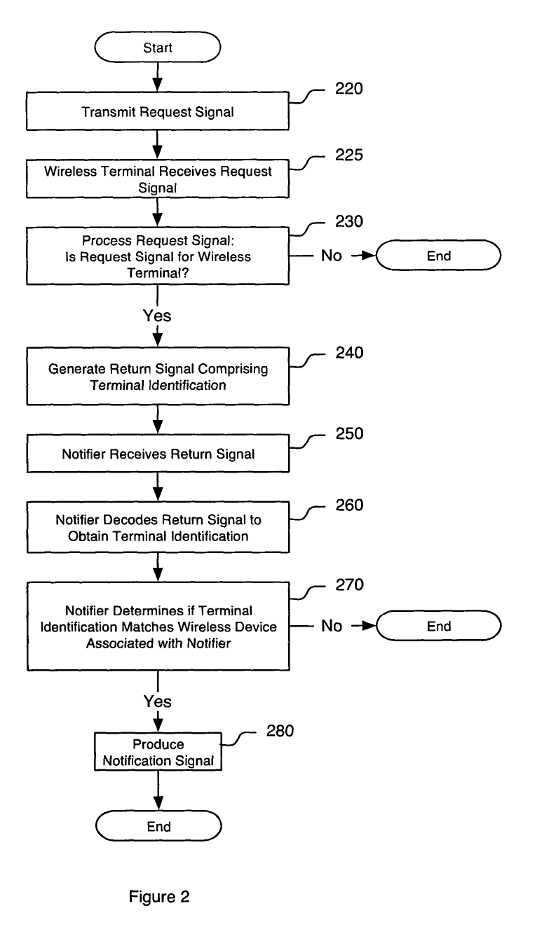

Turning now to FIG. 2, one embodiment of a method for practicing the present invention is shown. A base station transmits communication request signal 220. Request signal 220 is received by a wireless terminal 225. Wireless terminal processes the request signal to determine if the request signal is for the wireless terminal 230. If the result of step 230 is negative, the process ends or is otherwise processed (e.g., the wireless terminal may not be functional, out of range, or off. In such case, the calling party may be routed to voice mail, or to a standard network recording, depending on service option selected by the end user). If the result of step 230 is positive, a return signal is transmitted 240. Return signal comprises a termination identification associated with the wireless terminal. Return signal is received by a notifier device 250. Notifier decodes the return signal to obtain the terminal identification 260. Notifier determines if the terminal identification matches the wireless device associated with the notifier 270. If the result of step 270 is negative, the process ends. If the result of step 270 is positive, the notifier produces a notification signal to the end user 280, and the process ends.

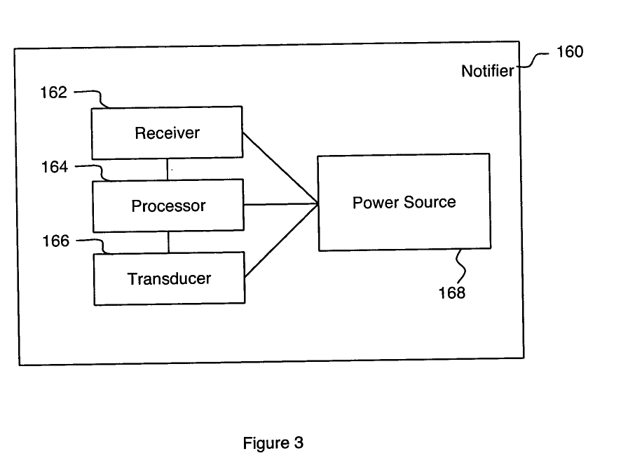

Turning now to FIG. 3, a block diagram of notifier 160 is shown. Notifier 160 comprises receiver 162 for receiving return signal 140, a decoder or processor 164 for obtaining or recovering terminal identification 142 from return signal 140, transducer 166 or some other mechanism to create end user notification signal 170, and power source 168. Each of receiver 162, decoder 164, transducer 166 and power source 168 are devices well known in the art. In one embodiment, an ASIC or other customer fabricated chip comprises one or more of the receiver 162, decoder/processor 164, and/or transducer 166. Thus, the size of notifier 160 can be greatly reduced by using such design and manufacturing techniques well know in the art.

As noted above receiver 162 may include the capability to tune to or receive multiple return signals 140. Decoder or processor 164 serves the function of decoding the received return signal 140 to ascertain terminal identification 142. In one embodiment, additional processing capabilities can be added to decoder 164 (or a separate processor can be added) to identify multiple terminal identifications 142 from multiple wireless terminals 130. In a further enhanced embodiment decoder or process 164 produces a different response to each of such different terminal identifications 142. Such different responses can then be used by transducer 166 to produce different notification signals 170. Transducer 166 is activated by decoder/processor 164. Transducer 166 serves the purpose of creating some form of notification signal 170 to the user. Such notification signal 170 may be in the form of a small electrical stimulation, light, sound, or other notification methods, or combinations of the above. As noted above, in one embodiment, different notification signals 170 are used to notify the user of different terminal identifications 142.

It will be obvious to those skilled in the art that the present invention may also be used in other similar wireless networking applications. For example, wireless communications transmitted in a restaurant (e.g., to indicate order is up), buildings (e.g., to page someone), or other similar applications. Thus, the above disclosed embodiments should not limit in any way the claims below.

What I claim as my invention is:

1. In a wireless network system, a method for notifying an end user of a wireless terminal of a request for communication, the method comprising the steps of:
receiving a return signal generated by the wireless terminal, said return signal comprising a terminal identification associated with said wireless terminal;
decoding said return signal to obtain said terminal identification; and
generating a notification signal in response to obtaining said terminal identification.

2. The method of claim 1 comprising a first and second steps of:
transmitting a request signal to a wireless terminal; and
in response to the request signal, transmitting said return signal from the wireless terminal.

3. The method of claim 1 wherein a plurality of return signals are received from a plurality of wireless terminals, each return signal comprising a termination identification associated with each of the plurality of wireless terminals.

4. The method of claim 3 wherein one or more of the plurality of return signals is decoded to obtain a terminal identification.

5. The method of claim 4 wherein the notification signal generated is unique to the decoded terminal identification.

6. The method of claim 1 wherein said notification signal is a tactile notification.

7. In a wireless network system, an apparatus for notifying an end user of a wireless terminal of a request for communication, the apparatus comprising:
a receiver for receiving a return signal generated by a wireless terminal, said return signal comprising a terminal identification;
a processor for obtaining the terminal identification in the return signal; and
a transducer for generating a notification signal in response to obtaining said terminal identification.

8. The apparatus of claim 7 wherein said receiver receives a plurality of return signals generated by a plurality of wireless terminals, each return signal comprising a termination identification associated with each wireless terminal.

9. The apparatus of claim 8 wherein the processor processes one or more of the plurality of return signals to obtain a terminal identification.

10. The apparatus of claim 9 wherein the transducer generates a unique notification signal associated with said obtained terminal identification.

11. The apparatus of claim 7 further comprising a power source to power the receiver, processor, and transducer.

11. The apparatus of claim 7 wherein the notification signal is a tactile notification.
